(19) United States
(12) Patent Application Publication
(10) Pub. No.: US 2019/0215160 A1
(43) Pub. Date: Jul. 11, 2019

(54) MANAGING A SET OF CRYPTOGRAPHIC KEYS IN AN ENCRYPTED SYSTEM

(71) Applicant: QUALCOMM Incorporated, San Diego, CA (US)

(72) Inventors: Darren LASKO, Forest, VA (US); Roberto Avanzi, Munchen (DE); Thomas Speier, Wake Forest, NC (US); Harb Abdulhamid, Durham, NC (US); Vikramjit Sethi, Austin, TX (US)

(21) Appl. No.: 15/865,994

(22) Filed: Jan. 9, 2018

(51) Int. Cl. H04L 9/08; G06F 21/60; G06F 21/72

(52) U.S. Cl. CPC H04L 9/0894; G06F 21/72; G06F 21/602

(57) ABSTRACT

Embodiments of the disclosure include systems and methods for storage of a first plurality of cryptographic keys associated with a first plurality of corresponding Protected Software Environments (PSEs) supervised by a PSE-management software running on a computer system and configured to supervise a superset of the plurality of PSEs. The computer system stores currently unused keys of the superset in a relatively cheap, large, and slow memory and caches the keys of the first plurality in a relatively fast, small, and expensive memory. In one embodiment, in a computer system having a first processor, a first memory controller, and a first RAM, the first memory controller has a memory cryptography circuit connected between the first processor and the first RAM, the memory cryptography circuit has a keystore and a first cryptographic engine, and the keystore is configured to store a first plurality of cryptographic keys accessible by a cryptographic-key identification.

### BACKGROUND

Embodiments of the present disclosure relate generally to integrated circuits (ICs) and more particularly, but not exclusively, to IC-implemented cryptographic systems.

Cryptography is used to keep a user's private data secure from unauthorized viewers by, for example, encrypting the user's data intended to be kept private, known as plaintext, into ciphertext that is incomprehensible to unauthorized viewers. The encoded ciphertext, which appears as gibberish, may then be securely stored and/or transmitted. Subsequently, when needed, the user or an authorized viewer may have the ciphertext decrypted back into plaintext. This encryption and decryption process allows a user to create and access private data in plaintext form while preventing unauthorized access to the private data when stored and/or transmitted in ciphertext form.

Encryption and decryption are conventionally performed by processing an input (plaintext or ciphertext, respectively) using a cryptographic key to generate a corresponding output (ciphertext or plaintext, respectively). A cryptographic system that uses the same key for both encryption and decryption is categorized as a symmetric cryptographic system. One popular symmetric cryptographic system is the Advanced Encryption Standard (AES), which is described in Federal Information Standards (FIPS) Publication 197.

Cryptographic systems may be used, for example, in a virtualized server environment, which allows a single physical server platform to be shared by multiple virtual machines (VMs). Note that the single physical server, which may comprise multiple processor cores on multiple IC devices, is operated as a single platform. The physical platform supports a hypervisor program, which manages the operation of multiple VMs on the physical platform. Note that a particular VM managed by the hypervisor may be actively running on the physical platform or may be stored in a memory in a suspended state. An active VM may access multiple different memory types and/or locations, some of which may be accessible to other VMs and/or other programs running on the platform (such as, for example, the hypervisor itself). A VM may also access the memory contents of another VM, or the memory contents of the hypervisor, provided that access control permits such accesses. To protect the confidentiality of each VM against physical attacks such as DRAM probing/snooping, a portion—up to the entirety—of the VM's contents may be encrypted. For effective security, each VM should use a unique (i.e., exclusive) corresponding cryptographic key. Systems and methods to manage keys for encryption and/or decryption of VM code and data may be useful.

### SUMMARY

The following presents a simplified summary of one or more embodiments to provide a basic understanding of such embodiments. This summary is not an extensive overview of all contemplated embodiments, and is intended to neither identify key or critical elements of all embodiments nor delineate the scope of any or all embodiments. The summary's sole purpose is to present some concepts of one or more embodiments in a simplified form as a prelude to the more detailed description that is presented later.

In one embodiment, an integrated circuit (IC) system comprises a first processor, a first memory controller, and a first random-access memory (RAM), wherein the first memory controller comprises a memory cryptography circuit, the memory cryptography circuit comprises a keystore and a cryptographic engine, the keystore comprises a plurality of storage spaces, each storage space accessible using a corresponding key identifier (KID), and wherein the keystore is configured to provide, in response to receiving a KID, a cryptographic key stored in the corresponding storage space.

In another embodiment, a method for an integrated circuit (IC) system comprising a first processor, a first memory controller, and a first random-access memory (RAM), wherein the first memory controller comprises a memory cryptography circuit, the memory cryptography circuit comprises a keystore and a cryptographic engine, and the keystore comprises a plurality of storage spaces, each storage space accessible using a corresponding key identifier (KID), comprises receiving, by the keystore, of a KID, accessing, by the keystore, the storage space corresponding to the KID, and providing, by the keystore, in response to receiving the KID, a cryptographic key stored in the corresponding storage space.

In yet another embodiment, a non-transitory computer readable medium has instructions stored thereon for causing an IC system comprising a first processor, a first memory controller, and a first random-access memory (RAM), wherein the first memory controller comprises a memory cryptography circuit, the memory cryptography circuit comprises a keystore and a cryptographic engine, and the keystore comprises a plurality of storage spaces, each storage space accessible using a corresponding key identifier (KID) to perform a method, the method comprising receiving, by the keystore, of a KID, accessing, by the keystore, the storage space corresponding to the KID, and providing, by the keystore, in response to receiving the KID, a cryptographic key stored in the corresponding storage space.

Moreover, the present disclosure also includes apparatus having components or configured to execute the above-described methods, and computer-readable medium storing one or more codes executable by a processor to perform the above-described methods.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

The disclosed embodiments will hereinafter be described in conjunction with the appended drawings, provided to illustrate and not to limit the disclosed embodiments, wherein like designations denote like elements, and in which:

FIG. 1 is a simplified schematic diagram of a computer system in accordance with one embodiment.

FIG. 2 is a simplified schematic diagram of a detailed portion of the computer system of FIG. 1.

FIG. 3 is a simplified schematic diagram of the memory cryptography circuit of FIG. 2.

FIG. 4 is a schematic representation of an exemplary data packet in accordance with one embodiment of the computer system of FIG. 2.

FIG. 5 is a flowchart for a process in accordance with one embodiment.

FIG. 6 is a flowchart of a process in accordance with one embodiment.

FIG. 7 is a flowchart of a process in accordance with one embodiment.

### DETAILED DESCRIPTION

Various embodiments are now described with reference to the drawings. In the following description, for purposes of explanation, specific details are set forth to provide a thorough understanding of one or more embodiments. It may be evident, however, that such embodiment(s) may be practiced without these specific details. Additionally, the term “component” as used herein may be one of the parts that make up a system, may be hardware, firmware, and/or software stored on a computer-readable medium, and may be divided into other components.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples. Note that, for ease of reference and increased clarity, only one instance of multiple substantially identical elements may be individually labeled in the figures.

Embodiments of the present disclosure include systems wherein each VM runs within a corresponding protected software environment (PSE). The PSEs are managed by PSE management software. Note that cryptographic protection may be applied to any arbitrary software layer (e.g., firmware, hypervisor, VM/kernel, driver, application, process, sub-process, thread, etc.). Any such software may function inside of a PSE. The hypervisor would typically be the PSE management software for PSEs that encapsulate VMs, and the OS kernel would typically be the PSE management software for PSEs that encapsulate applications. In general, the PSE management software role would typically be fulfilled by the software running at the next-higher privilege level from the software contained within a PSE.

Embodiments of the present disclosure include systems and methods for the storage of a first plurality of cryptographic keys associated with a first plurality of corresponding PSEs (e.g. encapsulating virtual machines) supervised by PSE management software (e.g. a hypervisor) running on a computer system and configured to supervise a superset of the plurality of PSEs. The computer system stores currently unused keys of the superset in a relatively cheap, large, and slow memory (e.g., DDR SDRAM) in encrypted form and caches the keys of the first plurality in a relatively fast, small, and expensive memory (e.g., on-chip SRAM) in plaintext form. In one embodiment, in a computer system having a first processor, a first memory controller, and a first RAM, the first memory controller has a memory cryptography circuit connected between the first processor and the first RAM, the memory cryptography circuit has a keystore and a first cryptographic engine, and the keystore comprises a plurality of storage spaces configured to store a first plurality of cryptographic keys accessible by a key identifier (KID).

In some embodiments, a computer system comprising one or more processors and capable of parallel processing is configured to support the secure and simultaneous (that is, parallel) operation of a plurality of PSEs, wherein the plurality of PSEs has a corresponding plurality of cryptographic keys—in other words, each PSE is associated with a corresponding cryptographic key. In addition, the computer system has a random-access memory shared by the plurality of PSEs. The computer system has a memory cryptography circuit (MCC) connected between the one or more processors and the shared memory, where the MCC includes a cryptography engine and a keystore for storing a subset of the plurality of cryptographic keys. During data transmission operations between the processor and the shared memory (for example, in the fetching of processor instructions, data reads, and data writes), the cryptography engine encrypts or decrypts the transmitted data (for example, processor instructions) using a corresponding cryptographic key stored in the keystore. The implementation of the MCC in hardware or firmware and the caching of likely-to-be-used keys in the keystore helps to allow for the rapid and efficient execution of cryptographic operations on the transmitted data.

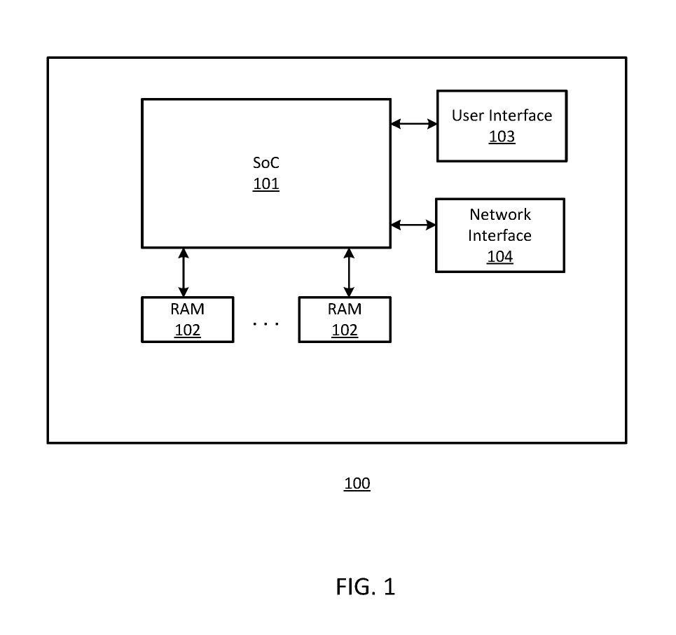

FIG. 1 is a simplified schematic diagram of a computer system 100 in accordance with one embodiment of the disclosure. Computer system 100 comprises a system on chip (SoC) 101 and one or more SoC-external random-access memory (RAM) modules 102, which may be, for example, double data rate (DDR) synchronous dynamic RAM (SDRAM) or any other suitable RAM. The computer system 100 also comprises user interface 103 and network interface 104. Note that, as would be appreciated by a person of ordinary skill in the art, the computer system 100, as well as any of its components, may further include any suitable assortment of various additional components (not shown) whose description is not needed to understand the embodiment.

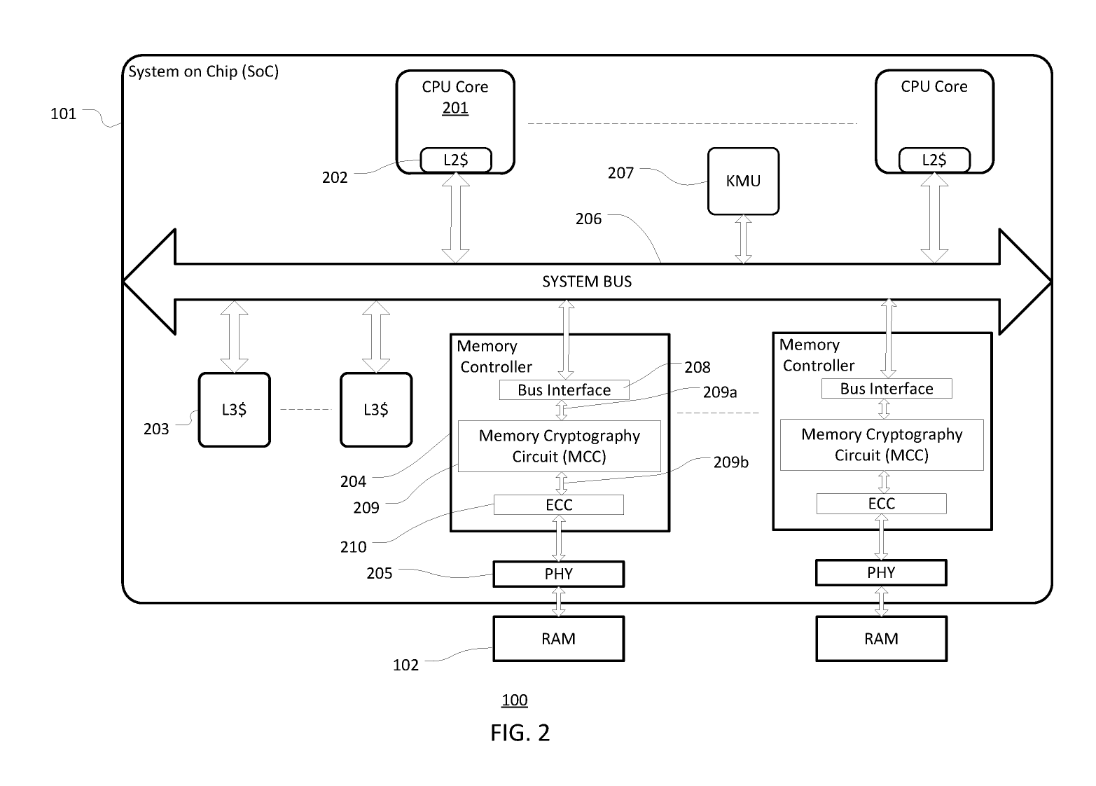

FIG. 2 is a simplified schematic diagram of a detailed portion of the computer system 100 of FIG. 1. The SoC 101 comprises one or more central processing unit (CPU) cores 201, each of which may be a single-threaded or multi-threaded processor. Each CPU core 201 may include an L1 cache (not shown) and an L2 cache 202. The SoC 101 further comprises one or more L3 caches 203, one or more memory controllers 204, one or more physical layer (PHY) interfaces 205, and a system bus 206. The SoC 101 further comprises a key management unit (KMU) 207, which may be implemented as a discrete standalone module as shown, as a distributed module within two or more CPU cores 201, or in any suitable manner. The system bus 206 interconnects the CPU cores 201, L3 caches 203, KMU 207, and memory controllers 204, along with any other peripheral devices which may be included within the SoC 101.

The memory controller 204 comprises a bus interface 208 connected to the system bus 206. The bus interface 208 is also connected, via a data path 209a, to a memory cryptography (MC) circuit (MCC) 209 that is, in turn, connected to an optional error-correction-code (ECC) circuit 210 via a data path 209b. Note that in alternative embodiments, the MCC 209 may connect to the PHY 205 without an intermediary ECC circuit. The memory controller 204 is communicatively coupled to a corresponding PHY interface 205, which is, in turn, communicatively coupled to a corresponding external RAM module 102.

The computer system 100 supports the management, by PSE management software, of a plurality of PSEs, where a subset of the plurality of PSEs may run simultaneously as parallel processes. The computer system 100 supports parallel processing by multiple CPU cores 201. In some implementations, one or more of the CPU cores 201 may be configured to execute multiple threads in parallel. Note that in some alternative embodiments, the computer system 100 may have only one CPU core 201, which, however, supports multi-threaded processing and, consequently, parallel processing. Further note that in some alternative embodiments, the computer system 100 may comprise two or more SoCs coherently connected through chip-to-chip interfaces to form a multi-socket system.

The computer system 100 may support an arbitrarily large number of PSEs, each associated with a unique cryptographic key, which allows for the secure sharing of RAM modules 102 by the CPU cores 201 and allows the PSEs to operate securely from snooping by other processes such as, for example, other PSEs, the PSE management software, and attackers with physical access to the computer system 100 (e.g., physical attackers). The SoC 101 may be designed to use time-slicing to support an almost-simultaneous execution of a number of PSEs that is greater than the number of parallel processes supportable by the SoC 101 on the corresponding CPU cores 201, but lesser than the arbitrarily large total number of PSEs supportable by the computer system 100. As will be explained in greater detail below, the KMU 207 stores and manages the cryptographic keys and corresponding KIDs for the PSEs supported by the computer system 100.

As will be explained in greater detail below, in operation, when a first PSE running on a first CPU core 201 needs to write a data block to a RAM 102, the data block is encrypted by the MC circuit 209 using a first cryptographic key uniquely corresponding to the first PSE. The corresponding encrypted data block is then written to a first RAM module 102. When the first PSE needs to read a data block from RAM module 102, the data block, which is encrypted on the RAM module 102, is decrypted by the MC circuit 209 using the first cryptographic key and the corresponding decrypted data block is then transmitted to the CPU core 201 on which the first PSE is running. Note that writing to and reading from RAM modules 102 may be performed as part of routine instruction execution by CPU cores 201.

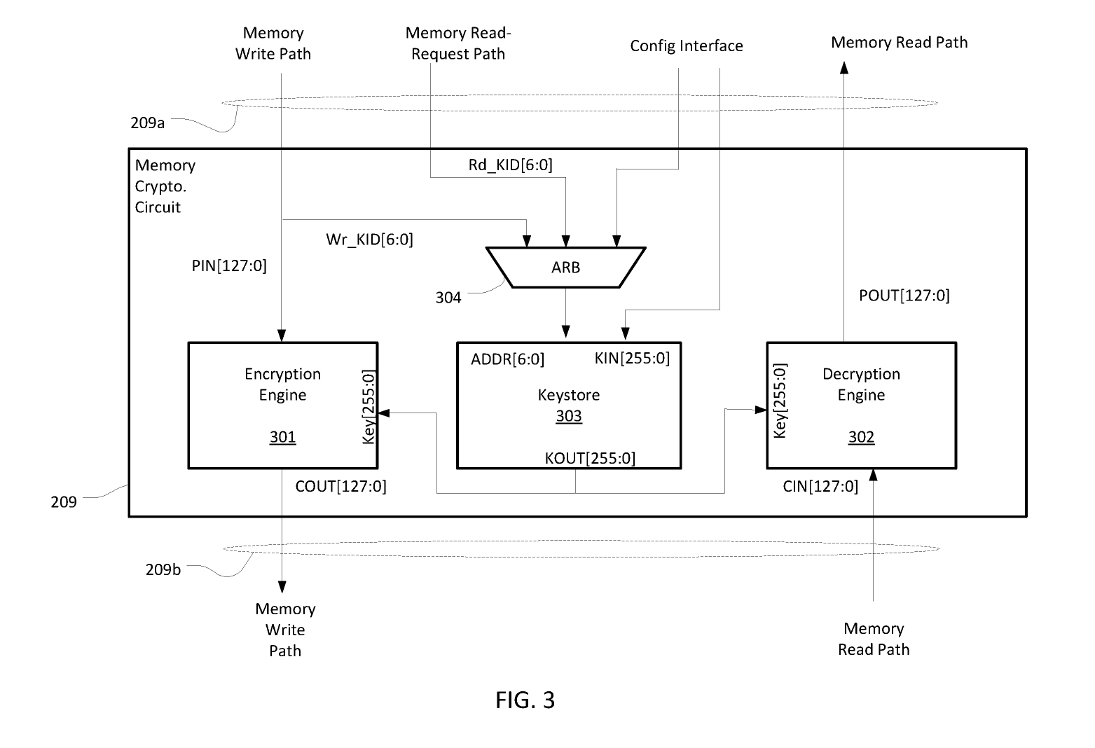

FIG. 3 is a simplified schematic diagram of the memory cryptography circuit 209 of FIG. 2. MC circuit 209 comprises an encryption engine 301, a decryption engine 302, a keystore 303, and an arbiter 304. The encryption engine 301 and the decryption engine 302 are two different types of cryptographic engines. The encryption engine 301 is a circuit configured to receive a block of plaintext and a cryptographic key, encrypt the plaintext with the cryptographic key using an encryption algorithm such as, for example, AES using an appropriate cipher mode of operation, and output a corresponding block of ciphertext. The decryption engine 302 is a circuit configured to receive a block of ciphertext and a cryptographic key, decrypt the ciphertext with the cryptographic key using a decryption algorithm such as, for example, AES using an appropriate cipher mode of operation, and output a corresponding block of plaintext. The keystore 303 may be a SRAM, register file, or similarly fast-access RAM configured to addressably store and update a plurality of cryptographic keys.

The keystore 303 is configured to receive a KID from the arbiter 304. In response to receiving a KID, the keystore 303 is configured to output the cryptographic key stored at the keystore address indicated by the KID. The output of the keystore 303 is connected to the cryptographic engines 301 and 302. The keystore 303 is also configured to receive, for storage, cryptographic keys from the Key Management Unit (KMU) 207 via the configuration interface. The KMU 207, via the configuration interface, provides, for example, a 256-bit cryptographic key and, via the arbiter 304, a corresponding KID. In response, the keystore 303 stores the received cryptographic key at the keystore address indicated by the KID.

The arbiter 304 is configured to receive a KID (i) from the CPU core 201 via the path 209a, and (ii) from the KMU 207 via the path 209a. Note that for both read and write requests, the KID is received from the CPU core 201. The KID is carried on the system bus 206 and may also be stored in the caches, where each cache lines carries the KID along with a memory address and data. Write requests from the CPU core 201 include plaintext data and the KID corresponding to the PSE running on the CPU core 201. Read requests from the CPU core 201 include a memory address and the PSE-corresponding KID. In response to the read request, the KID, or the corresponding key from the keystore 303, may be buffered by the MC circuit 209 until the ciphertext block located at the requested memory address is retrieved from the RAM 102, at which point, if the KID is buffered, then the KID is used to retrieve the corresponding key from the keystore 303. The ciphertext block and the key are then provided to the decryption engine 302.

The arbiter 304 multiplexes its KID inputs into one KID output provided to a KID input of the keystore 303. These arbiter 304 inputs may be referred to as, (i) memory write path, (ii) memory read-request path, and (iii) configuration interface path. The arbiter 304 may be configured to arbitrate among colliding KID inputs that are substantially simultaneously received based on, for example, assigned priority. In one implementation, KIDs associated with reads retrieved from the RAM module 102 are given the highest priority, KIDs associated with writes received from the CPU core 201 are given medium priority, and key updates received from the KMU are given the lowest priority. Note that alternative embodiments of the MC circuit 209 may forgo the arbiter 304 and, instead, have the KIDs provided directly to the keystore 303 and may have any suitable alternative mechanism for handling conflicting KID inputs to the keystore 303.

Note that each of the encryption engine 301 and the decryption engine 302 may be generically referred to as a cryptography engine. Note that, in some alternative embodiments, a single cryptography engine performs both encryption and decryption and additional circuitry provides the needed routing of data, address, and/or KID. Note that, in some alternative embodiments, the MC circuit 209 may have only one type of cryptography engine. In other words, in some alternative embodiments, the MC circuit 209 may have only an encryption engine and no decryption engine, or vice-versa.

In one implementation, the SoC 101 comprises sixteen single-threaded CPU cores 201, thereby allowing sixteen unique PSEs to run simultaneously. The PSE management software may be a program running distributed across one, some, or all of the CPU cores 201. The SoC 101 is configured to support thousands of PSEs and support time-slicing up to 128 PSEs at any one time. In other words, during normal operation, thousands of PSEs are suspended (in other words, are dormant), where a PSE's code and data exist in RAM encrypted with that PSE's key, but the PSE's corresponding cryptographic key is stored by the KMU in a relatively cheap, large, and slow memory (e.g., DDR SDRAM) in encrypted form, and therefore not immediately available for encrypting/decrypting that PSE's code and data. Meanwhile, scores of PSEs may be executing by time-slice sharing the sixteen CPU cores 201 of the SoC 101, where these PSEs' cryptographic keys are stored in the keystore 303 (a relatively fast, small, and expensive memory, e.g., on-chip SRAM) for rapid access by the cryptographic engines 301 and 302, where these PSEs' code and data may be stored in the RAM modules 102, and where up to sixteen of these PSEs may be executing simultaneously on the CPU cores 201.

Accordingly, the keystore 303 may be configured to cache 128 cryptographic keys. Each cryptographic key is stored in a corresponding 7-bit addressable (using the KID) memory location in the keystore 303. Note that a 7-bit address is usable to uniquely address 128 cryptographic-key locations (as 2⁷ equals 128). In one implementation, each cryptographic key is 256 bits.

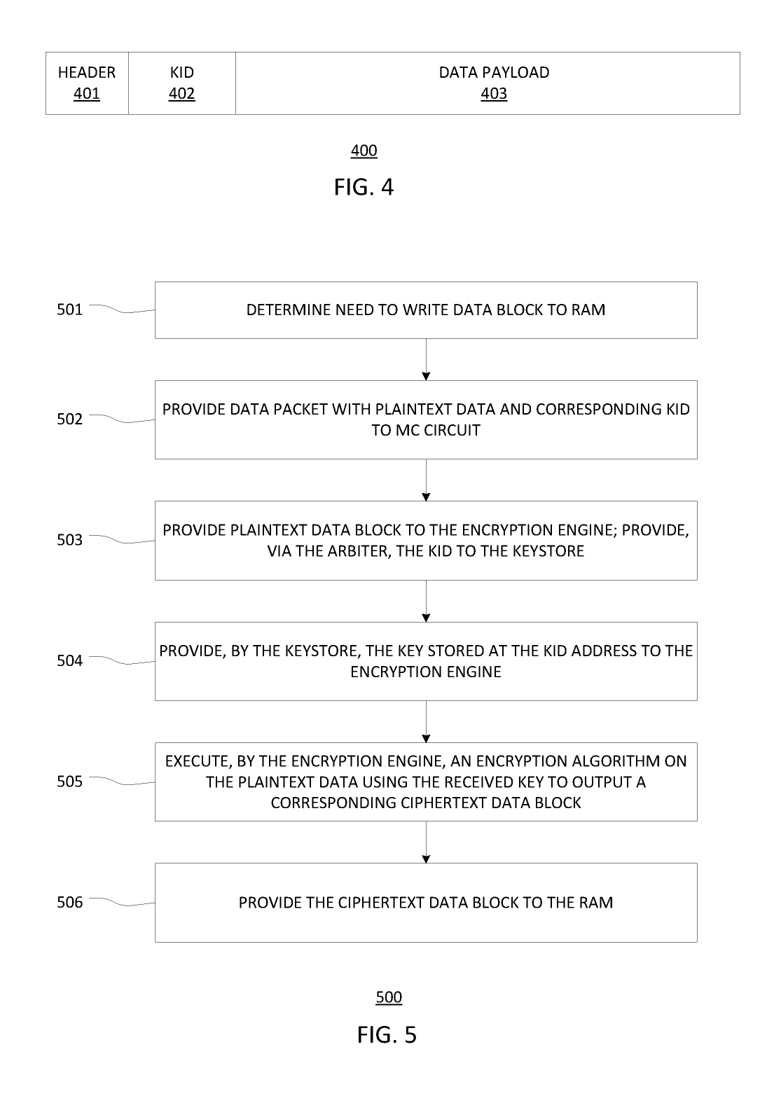

FIG. 4 is a schematic representation of an exemplary data packet 400 in accordance with one embodiment of the computer system 100 of FIG. 2. The data packet 400 includes a data payload 403, a key identifier (KID) 402, and a header 401. In one implementation, (i) the data payload field 403 is at least 128 bits so as to be able to contain an entire 128-bit standard AES block, and (ii) the KID field is at least 7 bits to support addressing 128 cryptographic-key locations in the keystore 303. The header 401 may contain any suitable header information, such as, for example, attribute information for transmission of the data packet 400 on the system bus 206 (e.g., memory address, read/write indicator, source address for routing response, etc.). Note that a read-request packet may include only a KID and a header, including a memory address, with no payload. Relatedly, a read-response packet may include only a data payload and a header with no KID. Note further that the KID, when used, does not have to be an exclusive-use segment of the data packet and may be, for example, part of the header and/or used for purposes other than identifying a key location in the keystore.

FIG. 5 is a flowchart for a process 500 in accordance with one embodiment. The process 500 starts when a determination is made by a writing module that a data block needs to be written to a RAM module 102 (step 501). The writing module may be made by, for example, a first PSE executing on a first CPU that needs to directly write a block to memory or a first cache that needs to evict a cache line. Note that, in general, write requests from a PSE executing on a CPU may be cached and, while in the cache hierarchy of SoC 101, the data block is associated with the KID of the PSE. The writing module provides to the MC circuit 209, via the system bus 206 and bus interface 208, a corresponding data packet 400, which comprises the plaintext data block in the data payload 403 and the KID corresponding to the first PSE in the KID field 402 (step 502). Note that the data payload 403 may include suffix and/or prefix padding bits together with the data block. The data payload 403 is provided to the encryption engine 301 and the KID is provided to the arbiter 304, which provides the KID to the keystore 303 (step 503).

The keystore 303 outputs the cryptographic key stored at the address specified by the KID and provides that key to the encryption engine 301 (step 504). The encryption engine 301 executes an encryption algorithm (e.g., AES encryption) on the received plaintext data using the received key and outputs a corresponding ciphertext data block (step 505). The ciphertext data block is then provided to the RAM module 102 (step 506).

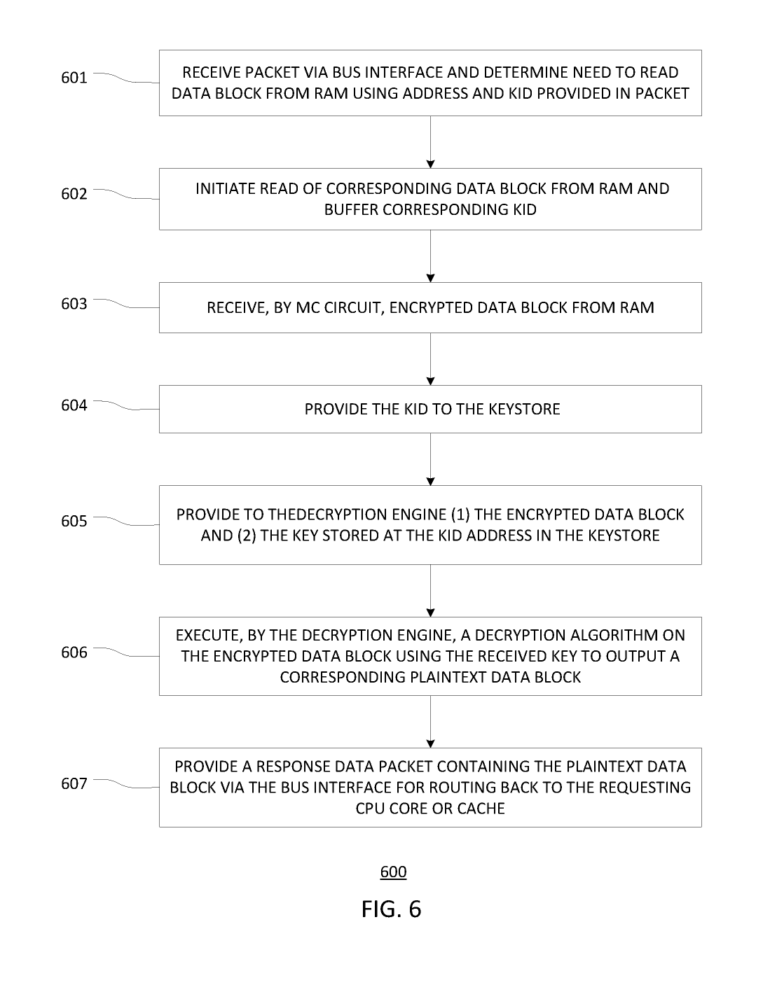

FIG. 6 is a flowchart of a process 600 in accordance with one embodiment. The process 600 starts when the memory controller 204 receives a data packet via the bus interface 208 and determines that a data block needs to be read (i.e., retrieved) from the RAM module 102 using the address and KID provided in the data packet (step 601). The data packet may be received from, for example, a CPU core 201, L2 cache 202, or L3 cache 203. The memory controller 204 initiates a read of the corresponding data block from the RAM module 102 and buffers the corresponding KID (step 602). The MC circuit 209 receives the requested encrypted data block from the RAM module 102 (step 603).

The KID is provided to the keystore 303 (step 604). The decryption engine 302 is provided (1) the retrieved encrypted data block and (2) the key stored at the KID address in the keystore 303 (step 605). The decryption engine 302 executes a decryption algorithm (e.g., AES decryption) on the received encrypted data block using the received key and outputs a corresponding plaintext data block (step 606). The memory controller 204 provides a response data packet containing the plaintext data block via the bus interface 208 for routing back to the requesting CPU core or cache (step 607).

Generic terms may be used to describe the steps of the above-described read and write processes 500 and 600. Determining needs to write or read data is determining a need to transfer data between the first PSE and a RAM module 102. Ciphertext and plaintext are data. Encryption and decryption are cryptographic operations, which take a first data block and output a first cryptographically corresponding data block.

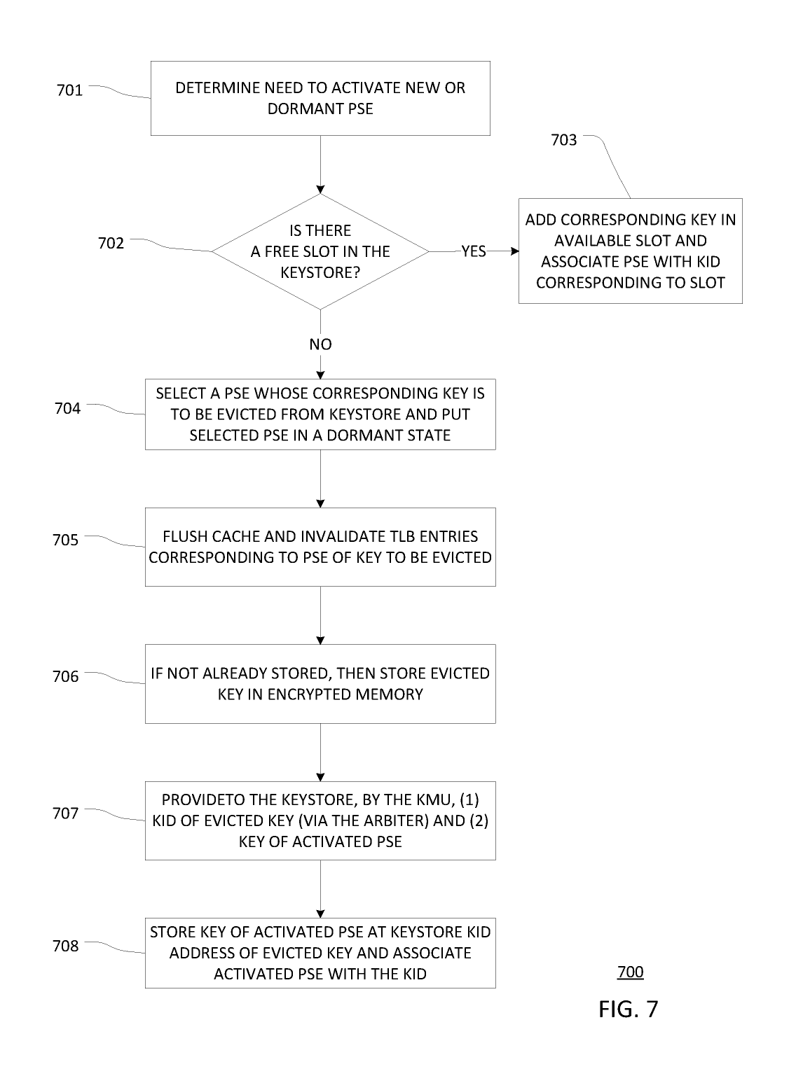

FIG. 7 is a flowchart of a process 700 in accordance with one embodiment. The process 700 starts when the PSE management software determines that a new or dormant PSE needs to be activated (step 701). In response to the determination, the PSE management software notifies the KMU 207, which determines if there is a free (e.g., empty) slot available in the keystore 303 (step 702). If there is, then the cryptographic key for the activating PSE is stored in the available slot in the keystore 303 and that activating PSE is associated with the KID corresponding to the keystore address of the available slot (step 703). If in step 702 it was determined that there is no free slot available in the keystore 303, then the KMU 207 selects a PSE whose corresponding key is to be evicted from the keystore 303 and puts the selected PSE in a dormant state (step 704). Any suitable algorithm—or combination of algorithms—may be used to determine which PSE to evict—for example, least used KID, randomly selected KID, sequentially selected KID, or lowest-priority-PSE KID.

Following the selection of the eviction PSE, the cache lines associated with the PSE of the key to be evicted are flushed and the translation lookaside buffer (TLB) entries associated with the PSE of the key to be evicted are invalidated (step 705). If not already stored, then the eviction PSE's corresponding cryptographic key is stored for possible later use, in a relatively cheaper, larger, and slower memory (e.g., DDR SDRAM) in encrypted form (step 706). The KMU 207 provides to the keystore 303 (1) via the arbiter 304, the KID of the evicted key and (2) the cryptographic key of the activation PSE (step 707) and the keystore 303 stores the cryptographic key of the activation PSE in the memory address indicated by the KID of the evicted key (step 708), thereby replacing the key of the eviction PSE with the key of the activation PSE in the keystore 303.

It should be noted that the above-described memory cryptography circuit may be used in systems other than computer system 100. For example, MC circuit 209 may be used in the management of encryption of so-called data at rest stored on shared non-volatile memory (e.g., on one or more non-volatile dual in-line memory modules NVDIMMs) by a plurality of filesystem, where each filesystem has a corresponding cryptographic key, similar to the above-described PSEs. In general, the memory cryptography circuit may be used in any suitable system where a relatively large plurality of clients and corresponding cryptographic keys are managed.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described embodiments may be described or claimed in the singular, the plural is contemplated unless limitation to the singular is explicitly stated. Additionally, all or a portion of any embodiment may be utilized with all or a portion of any other embodiment, unless stated otherwise. Thus, the disclosure is not to be limited to the examples and designs described herein but is to be accorded the widest scope consistent with the principles and novel features disclosed herein.

What is claimed is:

1. An integrated circuit (IC) system comprising a first processor, a first memory controller, and a first random-access memory (RAM), wherein:
the first memory controller comprises a memory cryptography circuit;
the memory cryptography circuit comprises a keystore and a cryptographic engine;
the keystore comprises a plurality of storage spaces, each storage space accessible using a corresponding key identifier (KID); and
the keystore is configured to provide, in response to receiving a KID, a cryptographic key stored in the corresponding storage space.

2. The IC system of claim 1, wherein:
the memory cryptography circuit is configured to receive a first input block and a corresponding first KID;
the memory cryptography circuit is configured to:
provide the first KID to the keystore;
provide, to the cryptographic engine, the first input block and a first cryptographic key provided by the keystore in response to receiving the first KID; and
the cryptographic engine is configured to perform a cryptographic operation on the first input block using the first cryptographic key provided by the keystore.

3. The IC system of claim 2, wherein:
the cryptographic engine is an encryption engine;
the cryptographic operation is an encryption of the first input block using the first cryptographic key;
the encryption outputs a corresponding ciphertext block that is provided to the first RAM.

4. The IC system of claim 3, wherein:
the memory cryptography circuit further comprises a decryption engine;
the memory cryptography circuit is configured to receive a second input block and a corresponding second KID;
the memory cryptography circuit is configured to:
provide the second KID to the keystore;
provide, to the decryption engine, the second input block and a second cryptographic key provided by the keystore in response to receiving the second KID;
the decryption engine is configured to perform a decryption operation on the second input block using the second cryptographic key provided by the keystore; and
the decryption engine outputs a corresponding plaintext block.

5. The IC system of claim 4, wherein:
the second input block is received from a second RAM; and
the second KID is received from a second processor.

6. The IC system of claim 2, wherein:
the first KID is received from the first processor;
the first input block is received from the first RAM;
the cryptographic engine is a decryption engine;
the cryptographic operation is a decryption of the first input block using the first cryptographic key;
the decryption outputs a corresponding plaintext block;
the plaintext block is provided to the first processor.

7. The IC system of claim 2, wherein:
the memory cryptography circuit further comprises a second-type cryptography engine;
the memory cryptography circuit is configured to receive a second input block and a corresponding second KID;
the memory cryptography circuit is configured to:
provide the second KID to the keystore;
provide, to the second-type cryptographic engine, the second input block and a second cryptographic key provided by the keystore in response to receiving the second KID; and
the second-type cryptographic engine is configured to perform a second-type cryptographic operation on the second input block using the second cryptographic key provided by the keystore, wherein the second-type cryptographic operation is different from the first-type cryptographic operation.

8. The IC system of claim 1, further comprising a key-management unit (KMU), wherein:
the KMU is configured to manage the keystore.

9. The IC system of claim 1, further comprising a first cache and a system bus interconnecting the first processor, the first memory controller, and the first cache, wherein:
the system bus is configured to carry a KID together with a corresponding memory address and data block; and
the first cache is configured to store a KID together with a corresponding memory address and data block.

10. The IC system of claim 1, wherein:
the IC system supports the operation of a plurality of protected software environments (PSEs);
the operation of the PSEs is managed by a PSE manager;
each PSE is associated with a corresponding cryptographic key; and
the first processor is configured to run a first PSE.

11. The IC system of claim 1, wherein:
the memory cryptography circuit further comprises an arbiter configured to multiplex a plurality of KID inputs into a single KID output provided to the keystore.

12. The IC system of claim 1, wherein the RAM is a synchronous dynamic RAM (SDRAM).

13. The IC system of claim 1, wherein the RAM is a non-volatile double in-line memory module (NVDIMM) RAM.

14. A method for an integrated circuit (IC) system comprising a first processor, a first memory controller, and a first random-access memory (RAM), wherein the first memory controller comprises a memory cryptography circuit, the memory cryptography circuit comprises a keystore and a cryptographic engine, and the keystore comprises a plurality of storage spaces, each storage space accessible using a corresponding key identifier (KID), the method comprising:
receiving, by the keystore, of a KID;
accessing, by the keystore, the storage space corresponding to the KID; and
providing, by the keystore, in response to receiving the KID, a cryptographic key stored in the corresponding storage space.

15. The method of claim 14, further comprising:
receiving, by the memory cryptography circuit, a first input block and a corresponding first KID;
providing, by the memory cryptography circuit, the first KID to the keystore;
providing, by the memory cryptography circuit, to the cryptographic engine, the first input block and a first cryptographic key provided by the keystore in response to receiving the first KID; and
performing, by the cryptographic engine, a cryptographic operation on the first input block using the first cryptographic key provided by the keystore.

16. The method of claim 15, wherein:
the cryptographic engine is an encryption engine;
the cryptographic operation is an encryption of the first input block using the first cryptographic key;
the encryption outputs a corresponding ciphertext block that is provided to the first RAM.

17. The method of claim 16, wherein the memory cryptography circuit further comprises a decryption engine and the method further comprises:
receiving, by the memory cryptography circuit, a second input block and a corresponding second KID;
providing, by the memory cryptography circuit, the second KID to the keystore;
providing, by the memory cryptography circuit, to the decryption engine, the second input block and a second cryptographic key provided by the keystore in response to receiving the second KID;
performing, by the decryption engine, a decryption operation on the second input block using the second cryptographic key provided by the keystore; and
outputting, by the decryption engine, a corresponding plaintext block.

18. The method of claim 15, wherein the memory cryptography circuit further comprises a second-type cryptography engine and the method further comprises:
receiving, by the memory cryptography circuit, a second input block and a corresponding second KID;
providing, by the memory cryptography circuit, the second KID to the keystore;
providing, by the memory cryptography circuit, to the second-type cryptographic engine, the second input block and a second cryptographic key provided by the keystore in response to receiving the second KID; and
performing, by the second-type cryptographic engine, a second-type cryptographic operation on the second input block using the second cryptographic key provided by the keystore, wherein the second-type cryptographic operation is different from the first-type cryptographic operation.

19. The method of claim 14, wherein the IC further comprises a first cache and a system bus interconnecting the first processor, the first memory controller, and the first cache, the method further comprising:
carrying, by the system bus, a KID together with a corresponding memory address and data block; and
storing, by the first cache, a KID together with a corresponding memory address and data block.

20. The method of claim 14, wherein the memory cryptography circuit further comprises an arbiter and the method further comprises:
multiplexing, by the arbiter, a plurality of KID inputs into a single KID output provided to the keystore.

21. A non-transitory computer readable medium having instructions stored thereon for causing an IC system comprising a first processor, a first memory controller, and a first random-access memory (RAM), wherein the first memory controller comprises a memory cryptography circuit, the memory cryptography circuit comprises a keystore and a cryptographic engine, and the keystore comprises a plurality of storage spaces, each storage space accessible using a corresponding key identifier (KID) to perform a method, the method comprising:
receiving, by the keystore, of a KID;
accessing, by the keystore, the storage space corresponding to the KID; and
providing, by the keystore, in response to receiving the KID, a cryptographic key stored in the corresponding storage space.
